(19) United States
(12) Patent Application Publication
(10) Pub. No.: US 2007/0103632 A1
(43) Pub. Date: May 10, 2007

(54) Liquid crystal display panel module and flexible printed circuit board thereof

(75) Inventors: Hui-Chang Chen, Kaohsiung City (TW); Wen-Hung Lai, Pingjhen City (TW); Chien-Liang Chen, Shueilin Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/361,629

(22) Filed: Feb. 24, 2006

(30) Foreign Application Priority Data
Nov. 7, 2005 (TW) 94138980

(51) Int. Cl. G02F 1/1345

(52) U.S. Cl. 349/149

(57) ABSTRACT

A liquid crystal display panel module and a flexible printed circuit board thereof. The liquid crystal display panel module includes a substrate and the flexible printed circuit board connected with the substrate. The flexible printed circuit board includes a base, a lead, a passivation layer and an insulation layer. The lead is disposed on the base, and has a first end portion and a second end portion. The passivation layer covers the lead without covering the first end portion. The insulation layer is disposed at an interface between the passivation layer and the first end portion to cover part of the passivation layer and part of the first end portion.

### BACKGROUND OF THE INVENTION

1. Field of the Invention

The present invention relates to a liquid crystal display panel module and a flexible printed circuit board thereof, and in particular, to a flexible printed circuit board with a lead that is difficult to be broken when bending.

2. Description of the Related Art

In a chip-on-glass (COG) liquid crystal display panel module, a flexible printed circuit board is typically utilized to combine a glass substrate and a printed circuit board.

FIG. 1 depicts a conventional COG liquid crystal display panel module comprising a glass substrate 110, a flexible printed circuit board 120, and a printed circuit board 140. Both the glass substrate 110 and the printed circuit board 140 are connected with the flexible printed circuit board 120 via an adhesive 130.

As shown in FIGS. 2a and 2b, the flexible printed circuit board 120 comprises a base 121, a plurality of leads 122, and a passivation layer 123. Since the flexible printed circuit board 120 requires smooth surfaces, the passivation layer 123 on the leads 122 is made of a polyimide (PI). Due to the hardness of polyimide, stress concentrates at an interface between the glass substrate 110 and the passivation layer 123, as shown in portions A and B of FIG. 1. After repeat bending, the leads 122 on the flexible printed circuit board 120 are broken. Additionally, since the thickness of the passivation layer 123 is about 12 μm to 25 μm, a gap is formed between the edge of the glass substrate 110 and the passivation layer 123. When foreign matter falls into the gap, the leads 122 may short circuit.

Thus, for the COG liquid crystal display panel module, it is important to prevent the leads on the flexible printed circuit board from breaking after repeated bending.

In U.S. Pat. No. 6,657,606, a flexible printed circuit board is provided to prevent leads thereon from breaking after repeated bending. Nevertheless, the flexible printed circuit board in U.S. Pat. No. 6,657,606 is applied to a chip-on-film (COF) liquid crystal display panel module, but not to the COG liquid crystal display panel module.

### BRIEF SUMMARY OF THE INVENTION

Liquid crystal display panel modules are provided. An exemplary embodiment of a liquid crystal display panel module comprises a substrate and a flexible printed circuit board connected with the substrate. The flexible printed circuit board comprises a base, a lead, a passivation layer, and a first passivation layer. The lead is disposed on the base, and has a first end portion and a second end portion. The passivation layer covers the lead without covering the first end portion. The first insulation layer is disposed at an interface between the passivation layer and the first end portion to cover part of the passivation layer and part of the first end portion.

Furthermore, the liquid crystal display panel module comprises an adhesive disposed between the substrate and the flexible printed circuit board. The adhesive may be in contact with the first insulation layer. Alternatively, the adhesive may be disposed without contacting the first insulation layer. The adhesive comprises an anisotropic conductive film, a nonconductive film, an anisotropic conductive paste, or a nonconductive paste.

Additionally, the first insulation layer has a hardness lower than that of the passivation layer. The passivation layer comprises a polyimide. The first insulation layer comprises a resin, and the resin comprises a solder resist or a photo resist. The lead comprises electrolytically deposited copper or rolled annealed copper.

Moreover, the liquid crystal display panel module comprises a printed circuit board connected with the flexible printed circuit board. The flexible printed circuit board further comprises a second insulation layer disposed at an interface between the passivation layer and the second end portion to cover part of the passivation layer and part of the second end portion. An adhesive is disposed between the printed circuit board and the flexible printed circuit board.

Note that the liquid crystal display panel module is a chip-on-glass liquid crystal display panel module.

Flexible printed circuit boards are provided. An exemplary embodiment of a flexible printed circuit board comprises a base, a lead, a passivation layer, and a first passivation layer. The lead is disposed on the base, and has a first end portion and a second end portion. The passivation layer covers the lead without covering the first end portion. The first insulation layer is disposed at an interface between the passivation layer and the first end portion to cover part of the passivation layer and part of the first end portion.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional chip-on-glass liquid crystal display panel module;

FIG. 2a is a schematic view of a flexible printed circuit board in FIG. 1;

FIG. 2b is another schematic view of the flexible printed circuit board in FIG. 1;

FIG. 3 is a schematic view of an embodiment of a liquid crystal display panel module;

FIG. 4a is a schematic view of a flexible printed circuit board in FIG. 3;

FIG. 4b is another schematic view of the flexible printed circuit board in FIG. 3;

FIG. 5 is a schematic view of another embodiment of a liquid crystal display panel module; and

FIG. 6 is a schematic view of a variant embodiment of a flexible printed circuit board.

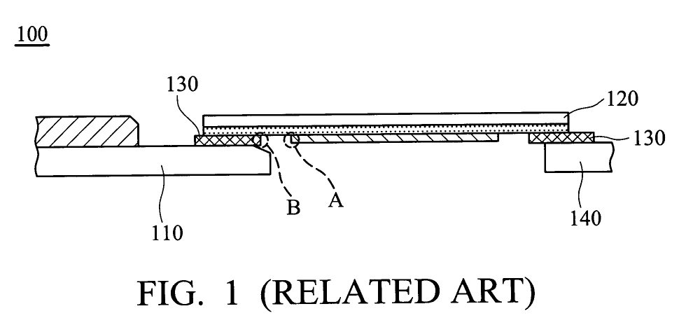

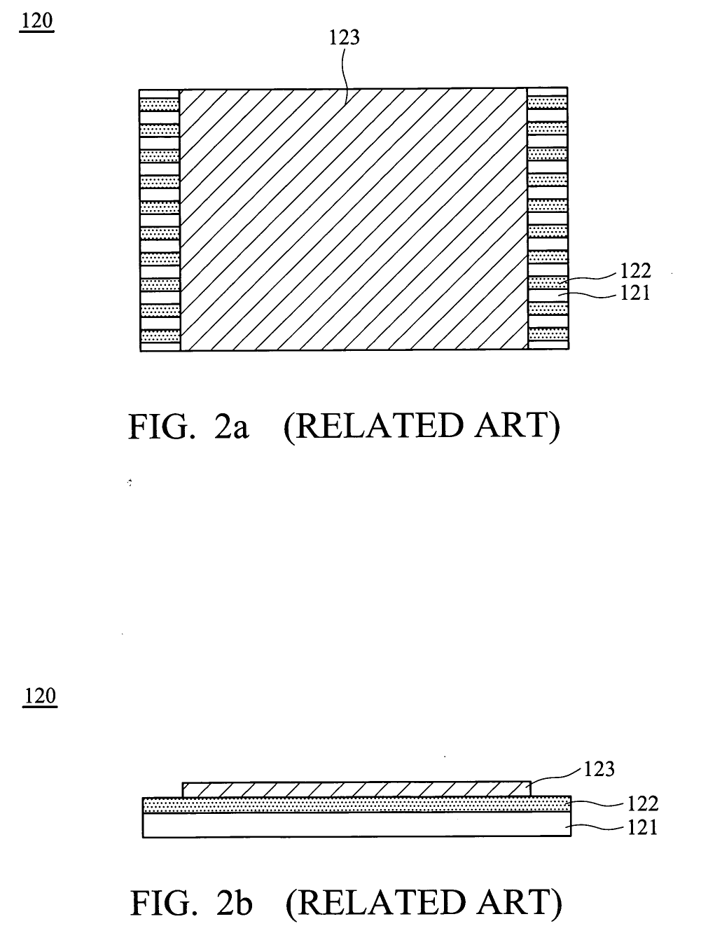

### DETAILED DESCRIPTION OF THE INVENTION

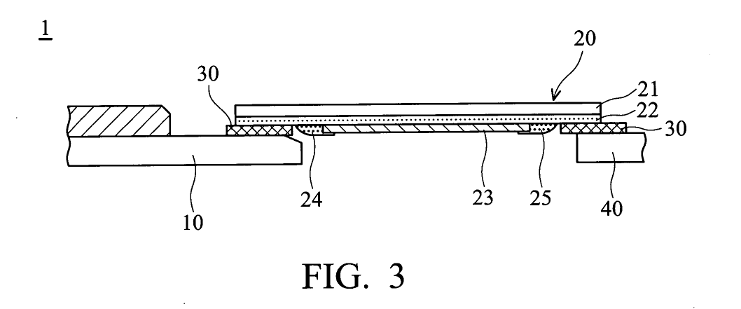

Referring to FIG. 3, an embodiment of a liquid crystal display panel module 1 comprises a glass substrate 10, a flexible printed circuit board 20, and a printed circuit board 40. Both the glass substrate 10 and the printed circuit board 40 are connected with the flexible printed circuit board 20 via an adhesive 30.

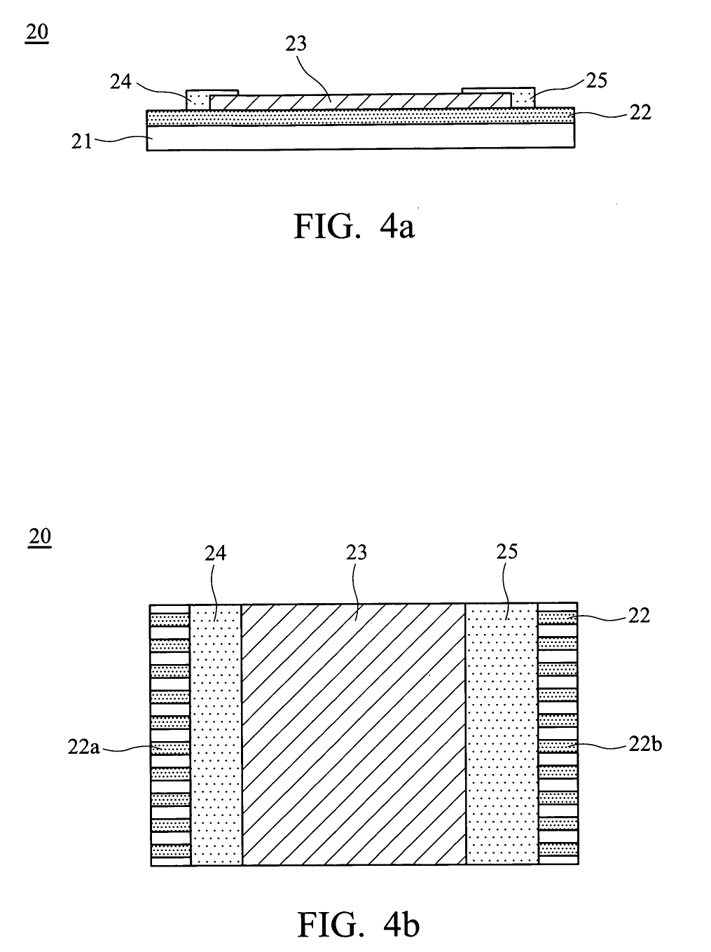

Referring to FIGS. 4a and 4b, the flexible printed circuit board 20 comprises a base 21, a plurality of leads 22, a passivation layer 23, a first passivation layer 24, and a second insulation layer 25. Each lead 22 is disposed on the base 21, and has a first end portion 22a and a second end portion 22b. The passivation layer 23 covers the leads 22 without covering the first end portion 22a and the second end portion 22b. The passivation layer 23 may be made of a polyimide.

The first insulation layer 24 is disposed at an interface between the passivation layer 23 and the first end portion 22a to cover part of the passivation layer 23 and part of the first end portion 22a. Similarly, the second insulation layer 25 is disposed at an interface between the passivation layer 23 and the second end portion 22b to cover part of the passivation layer 23 and part of the second end portion 22b. Note that the hardness of the first and second insulation layers 24 and 25 is lower than that of the passivation layer 23. Additionally, the first and second insulation layers 24 and 25 are made of a resin that may be a solder resist or a photo resist.

Referring to FIG. 3, the adhesive 30 is disposed between the substrate 10 and the flexible printed circuit board 20 to connect the flexible printed circuit board 20 with the substrate 10. Also, the adhesive 30 is disposed between the printed circuit board 40 and the flexible printed circuit board 20 to connect the printed circuit board 40 with the flexible printed circuit board 20. The adhesive 30 may be an anisotropic conductive film (ACF), a nonconductive film (NCF), an anisotropic conductive paste (ACP), or a nonconductive paste (NCP).

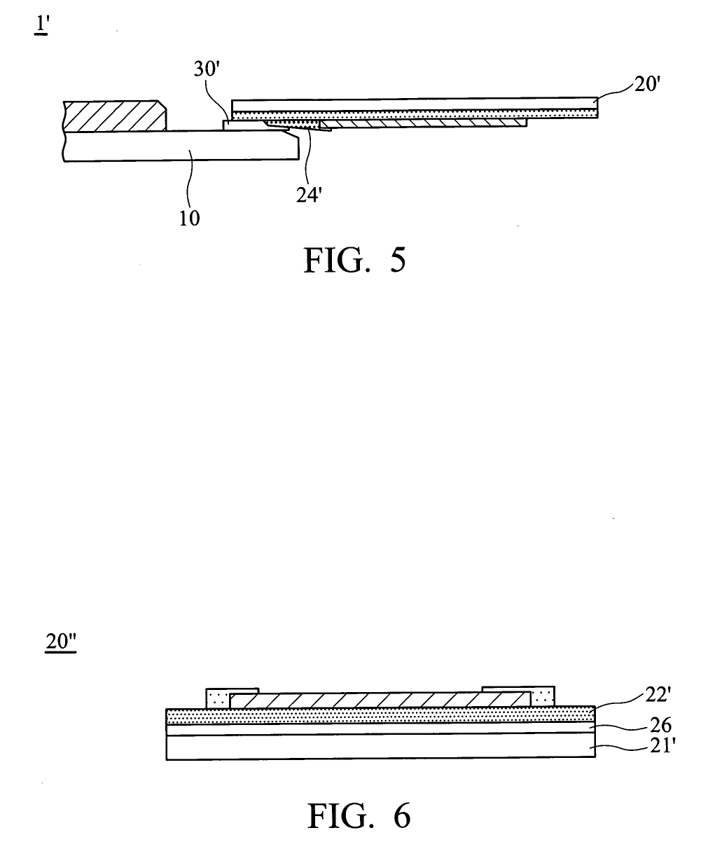

Note that the adhesive 30 is disposed without contacting with the first and second insulation layers 24 and 25 in FIG. 3; however, it is not limited to this. For example, as shown in FIG. 5, an adhesive 30′ is in contact with a first insulation layer 24′ in a liquid crystal display module 1′. Thus, foreign matter cannot contact the exposed leads causing short circuits. Furthermore, although only the first insulation layer 24′ is shown in FIG. 5, the second insulation layer can be disposed so as to not contact the adhesive based on requirements.

Additionally, although the insulation layers are disposed at both end portions of the leads in FIG. 3, they are not limited to this. Based on requirements, only one insulation layer can be disposed on the leads. Furthermore, the structure of the flexible printed circuit board is not limited to that shown in FIG. 4a. For example, as shown in FIG. 6, an adhesive layer 26 may be disposed between a base 21′ and a passivation layer 22′ in a flexible printed circuit board 20″. Note that the liquid crystal display panel module is a chip-on-glass liquid crystal display panel module.

As previously described, the insulation layer with lower hardness is disposed at the interface between the leads and the passivation layer to prevent the leads around the edge of the flexible printed circuit board from breaking after repeated bending. Thus, the insulation layer can enhance the flexibility and endurance of the leads without affecting the flatness of the flexible printed circuit board. As a result, since the flexibility and endurance are enhanced, the lead material is not limited to rolled annealed copper, and may be made with lower cost electrolytically deposited copper.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display panel module comprising:
a substrate; and
a flexible printed circuit board, connected with the substrate, comprising:
a base;
a lead, disposed on the base, having a first end portion and a second end portion;
a passivation layer covering the lead without covering the first end portion; and
a first insulation layer disposed at an interface between the passivation layer and the first end portion to cover part of the passivation layer and part of the first end portion.

2. The liquid crystal display panel module as claimed in claim 1, further comprising an adhesive disposed between the substrate and the flexible printed circuit board.

3. The liquid crystal display panel module as claimed in claim 2, wherein the adhesive is in contact with the first insulation layer.

4. The liquid crystal display panel module as claimed in claim 2, wherein the adhesive is disposed without contacting with the first insulation layer.

5. The liquid crystal display panel module as claimed in claim 2, wherein the adhesive comprises an anisotropic conductive film, a nonconductive film, an anisotropic conductive paste, or a nonconductive paste.

6. The liquid crystal display panel module as claimed in claim 1, wherein the first insulation layer has a hardness lower than that of the passivation layer.

7. The liquid crystal display panel module as claimed in claim 1, wherein the passivation layer comprises a polyimide.

8. The liquid crystal display panel module as claimed in claim 1, wherein the first insulation layer comprises a resin.

9. The liquid crystal display panel module as claimed in claim 8, wherein the resin comprises a solder resist or a photo resist.

10. The liquid crystal display panel module as claimed in claim 1, wherein the lead comprises electrolytically deposited copper or rolled annealed copper.

11. The liquid crystal display panel module as claimed in claim 1, further comprising a printed circuit board connected with the flexible printed circuit board, wherein the flexible printed circuit board further comprises a second insulation layer disposed at an interface between the passivation layer and the second end portion to cover part of the passivation layer and part of the second end portion.

12. The liquid crystal display panel module as claimed in claim 11, further comprising an adhesive disposed between the printed circuit board and the flexible printed circuit board.

13. The liquid crystal display panel module as claimed in claim 12, wherein the adhesive is in contact with the second insulation layer.

14. The liquid crystal display panel module as claimed in claim 12, wherein the adhesive is disposed without contacting with the second insulation layer.

15. The liquid crystal display panel module as claimed in claim 12, wherein the adhesive comprises an anisotropic conductive film, a nonconductive film, an anisotropic conductive paste, or a nonconductive paste.

16. The liquid crystal display panel module as claimed in claim 11, wherein the second insulation layer has a hardness lower than that f the passivation layer.

17. The liquid crystal display panel module as claimed in claim 11, wherein the second insulation layer comprises a resin.

18. The liquid crystal display panel module as claimed in claim 17, wherein the resin comprises a solder resist or a photo resist.

19. The liquid crystal display panel module as claimed in claim 1, wherein the liquid crystal display panel module is a chip-on-glass liquid crystal display panel module.

20. A flexible printed circuit board, comprising:
a base;
a lead, disposed on the base, having a first end portion and a second end portion;
a passivation layer covering the lead without covering the first end portion; and
a first insulation layer disposed at an interface between the passivation layer and the first end portion to cover part of the passivation layer and part of the first end portion.

21. The flexible printed circuit board as claimed in claim 20, wherein the first insulation layer has a hardness lower than that of the passivation layer.

22. The flexible printed circuit board as claimed in claim 20, wherein the first insulation layer comprises a resin.

23. The flexible printed circuit board as claimed in claim 22, wherein the resin comprises a solder resist or a photo resist.

24. The flexible printed circuit board as claimed in claim 20, wherein the lead comprises electrolytically deposited copper or rolled annealed copper.

25. The flexible printed circuit board as claimed in claim 20, wherein the passivation layer comprises a polyimide.

26. The flexible printed circuit board as claimed in claim 20, further comprising a second insulation layer disposed at an interface between the passivation layer and the second end portion to cover part of the passivation layer and part of the second end portion.

27. The flexible printed circuit board as claimed in claim 26, wherein the second insulation layer has a hardness lower than that of the passivation layer.

28. The flexible printed circuit board as claimed in claim 26, wherein the second insulation layer comprises a resin.

29. The flexible printed circuit board as claimed in claim 28, wherein the resin comprises a solder resist or a photo resist.
